(19) United States
(12) Patent Application Publication
(10) Pub. No.: US 2007/0202460 A1
(43) Pub. Date: Aug. 30, 2007

(54) Graft holder

(76) Inventor: John Chao, Alhambra, CA (US)

Correspondence Address: FOLEY & LARDNER, 2029 CENTURY PARK EAST, SUITE 3500, LOS ANGELES, CA, 90067, US

(21) Appl. No.: 11/709,930

(22) Filed: Feb. 22, 2007

Related U.S. Application Data
(60) Provisional application No. 60/775,766, filed on Feb. 22, 2006.

(51) Int. Cl. A61C 3/00

(52) U.S. Cl. 433/141

(57) ABSTRACT

An instrument for performing periodontal surgery, the instrument comprising a handle, a connector section comprising a first end and a second end, the first end connecting to the handle and a bracing member connecting to the second end of the connector section where the handle and the first end of the connector section forms a first angle; and the second end of the connector section and the planar section forms a second angle in the same direction as the second angle.

### CROSS-REFERENCE TO RELATED PATENT APPLICATIONS

This application claims priority under 35 USC §119(e) from U.S. Provisional Application Ser. No. 60/775,766, filed Feb. 22, 2006 entitled “Graft-Holder,” the entirety of which is incorporated herein by reference.

### BACKGROUND

The present invention relates generally to the instruments for performing periodontal surgeries.

### RELATED ART

Dental surgeries, such as tooth extractions, gingival defects and guided tissue regeneration require precise placement of grafted tissue. The precise placement of the graft or membrane at the graft site can be achieved by suturing the graft or membrane intraorally at the graft site. However on other occasions, the precise placement can also be achieved by suturing the graft extraorally and completing the suturing at the graft site.

Gum diseases, such as periodontitis and gingivitis, can cause damages to the gum near the root of a tooth. In some cases, the gum line near a tooth can recede, exposing the root of the tooth in a condition known gingival recession. The receded gum line is called a gingival defect. The gingival defect of a receding gum near the root of a tooth can be unsightly, can cause discomfort, and can lead to severe damages to the gum and tooth.

When a gingival defect becomes severe, it is sometimes necessary to use periodontal surgeries to correct this defect. There are several conventional methods of performing gingival defect correction surgeries (also known as gingival augmentation surgeries).

A common approach (for root coverage) involves making large incisions and grafting tissues to the gum to cover the gingival defect. First, a horizontal incision is made along the gum line where the gum comes into contact with the teeth (also known as the gingival margin). This horizontal incision is made around the affected tooth or group of teeth and the immediately adjacent teeth. Next, two vertical incisions, along the length direction of the teeth, are made at the two ends of the horizontal incision. The vertical incisions are made from the horizontal incision to the muco-gingival junction.

Next, a flap is created by elevating the flap defined by the horizontal and vertical incisions, either in the upward direction for surgeries on the an upper tooth, or in the downward direction for a lower tooth, thus exposing the underlying bone. Then new tissues are grafted under the flap onto existing tissues. The new grafted tissues can come from the patient's own tissues, or from human donor or animal tissues. The new grafted tissue is small in size. Due to the small size of the graft, it is time consuming for even an experienced practitioner to place it and suture it into the correct aesthetic location and size. One embodiment of the current invention provides stabilization of the new grafted tissue for suturing and another embodiment allows for proper placement and suturing of the graft into the gingival defect. After the grafting of new tissues, the flap is closed down onto the grafted tissues, and the incisions are closed using multiple sutures.

While this surgery technique is capable of repairing gingival defects for one tooth or a group of adjacent teeth, it can be a complicated surgery with a relatively long recovery time and significant morbidity. One embodiment of the invention allows for greater control over the new tissue graft.

Further embodiments of the invention may be used for post tooth extraction procedures. Often there is a need for a granular bone graft to be placed into the socket created from a tooth extraction, in order to avoid bone shrinkage in the socket. After the bone graft is placed into the socket there is a need to put a membrane to cover the graft. The membrane is made of soft or gum tissue such as but not limited to gingival, autogenous, allographic or xenographic tissue. The membrane must be fixated in order to preserve the bone and enable recovery. Suturing is traditionally used to keep the membrane in the fixed place. The membrane can be small, slippery and wet leading to movement during suturing.

Embodiments of the graft holder can keep the membrane stationary while the surgeon sutures intraorally or extraorally. Other embodiments can allow for precise suturing by allowing a hole for the suturing needle to pass through. While another embodiment allows for the membrane to be held in place using serrated edges and allowing for suturing around the instrument. The result of a precisely placed membrane can save time during surgery and shorten recovery time for the patient.

During bone grafting or implant procedures, guided tissue regeneration is needed to enhance bone growth another procedure that requires membrane placement in a precise location. Guided tissue regeneration is sometimes used when there is an implant placed under the bone and there is a region of the abutment that protrudes out of the bone. A membrane is placed between gum tissue and the implant or placed over bone graft and between the bone in order to allow guided tissue regeneration. Again there is a need for an intraoral or extraoral instrument that can hold the implant in place while suturing.

The above-described surgical methods are typically executed using conventional instruments that are not designed specifically for membrane grafting procedures. The design of these instruments, in terms of size, angulations of connectors and other characteristics are not optimal for such suturing procedures. Such instruments were not specifically designed for minimally invasive gingival or papillae augmentation surgeries where fixation of the graft during suturing can be helpful. Because most conventional instruments are not designed in particular to be used for fixating graft specimens, the use of these instruments can result in movement of the graft during suturing or imprecise placement of the graft due to awkward operating angles for the surgeon.

Therefore, because of the disadvantages and limitations of the conventional instruments which are not designed for holding, stabilization or fixating the graft specimen, it can be highly desirable to have a surgical method and instruments which enables the efficient correction of severe gingival defects of varying degrees with the best and most precise placement of the graft. In addition, a technique that eliminates operator error saves the surgeon operating time and minimizes tissue trauma and patient discomfort. In addition, it is also highly desirable to have instruments designed especially for performing gingival defect correction surgeries (gingival or papillae augmentation surgeries) with the characteristics described above to minimize the incision size and increase the surgeon's or operator's efficiency and success rate.

Furthermore, the risk of percutaneous injury to the hands of the surgeon during suturing is greatly reduced by the ability of the surgeon to place, fixate and suture the graft at the precise location when these instruments are available for use. Suturing has been identified as one of the factors associated with percutaneous punctures and disease transmission from patient to the surgeon by the Center for Disease Control.

### SUMMARY OF THE DISCLOSURE

Embodiments of the present invention relate generally to surgical instruments for periodontal surgeries, such as a gingival or papillae augmentation, post tooth extraction with bone grafting, and guided tissue regeneration for implants. Further, the embodiments of the surgical instruments have designs that maximizes efficiency of the operation by reducing errors and allowing for aesthetic placement of membranes and grafts.

An instrument for performing periodontal surgery, the instrument comprising, a handle, a connector section comprising a first end and a second end, the first end connecting to the handle and a bracing member connecting to the second end of the connector section wherein, the handle and the first end of the connector section forms a first angle, the second end of the connector section and the planar section forms a second angle in the same direction as the first angle.

In periodontal surgery it is sometimes necessary to suture a graft specimen prior to placement onto the graft site. Graft specimens are slippery and wet. Embodiments of the Graft Holder allow the graft to be tucked securely against the serrated end and laid on the flat surface of the instrument. The surgeon can pass the needle and suture through the specimen in a direction away from the serrated end.

In another embodiment, the Graft Holder has two prongs that allow for holding the graft in place during suturing of the graft to soft tissue. The use of this embodiment leads to exemplary placement and stabilization of the graft while it is being sutured at the gingival defect site.

The embodiments of the invention allows for greater flexibility by enabling suturing intra orally and extra orally.

### BRIEF DESCRIPTION OF THE DRAWINGS

FIG. 1 illustrates one embodiment of the graft holder being used to hold a graft intraorally, for example, as part of a surgical procedure.

FIG. 2 illustrates a graft holder according to the embodiment of FIG. 1, but holding the graft extraorally and a suture needle going through two prongs and the graft membrane on a sterilized surface.

FIG. 3 illustrates a side view of the graft holder instrument according to the embodiment of FIGS. 1-2.

FIG. 4 illustrates a top view of the graft holder instrument according to the embodiment of FIGS. 1-3.

FIG. 5 illustrates a bottom view of an instrument according to the embodiment of FIGS. 1-4.

FIG. 6 illustrates one embodiment of the graft holder being used to hold a graft extraorally and a suture needle going through the graft membrane on a sterilized surface.

FIG. 7 illustrates a side view of an embodiment of the instruments in FIG. 6.

FIG. 8 illustrates a bottom view of the instrument in FIG. 6, showing the serrations used to control the graft.

FIG. 9 illustrates a bottom view of the instrument in FIGS. 6, 7 and 8, showing an embodiment of the tapering.

FIG. 10a illustrates a perspective view of the graft holder, this embodiment allows for greater angulation and allows the practitioner to reach further into the mouth of the patient.

FIG. 10b illustrates a perspective view of the graft holder, this embodiment allows for greater angulation and allows the practitioner to reach further into the mouth of the patient.

FIG. 11 illustrates a view of the graft holders from FIG. 10a and 10b inserted into an incision site.

### DETAILED DESCRIPTION

Embodiments of graft holder instruments described herein may be used in various surgeries and operations that require holding a graft specimen or membrane in a particular location. The graft holder instrument may be used to hold a graft stationary relative to a surgical site, during surgery. Various embodiments of graft holder instruments are designed to facilitate accurate placement of the graft or soft tissue leading to faster recoveries and efficient use of the surgeons time.

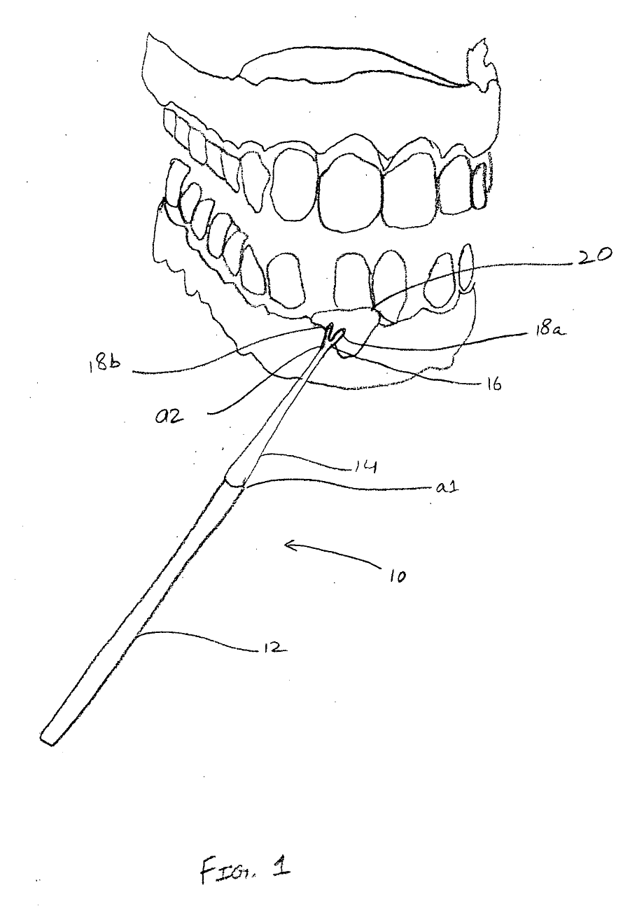

FIGS. 1-5 illustrate the first set of embodiments of the graft holder. FIG. 1 shows an embodiment of the graft holder being used to hold a graft specimen or membrane secure against a graft site.

As illustrated in FIG. 1, the graft holder 10 is an instrument with a handle 12, a first connector section or first shank 14 linearly extending from the handle 12 at an angle a1, a second connector section or second shank 16 linearly extending from the first shank at an angle a2 and a bracing member linearly extending from the second shank. The bracing member comprises forked tip with rounded protrusions 18a and 18b that are parallel to each other, with space between the protrusions 18a and 18b. In other embodiments, the rounded protrusions 18a and 18b can be converging or diverging. As further shown in FIG. 1, the forked protrusions 18a and 18b brace against the graft specimen 20 at a graft site intraorally.

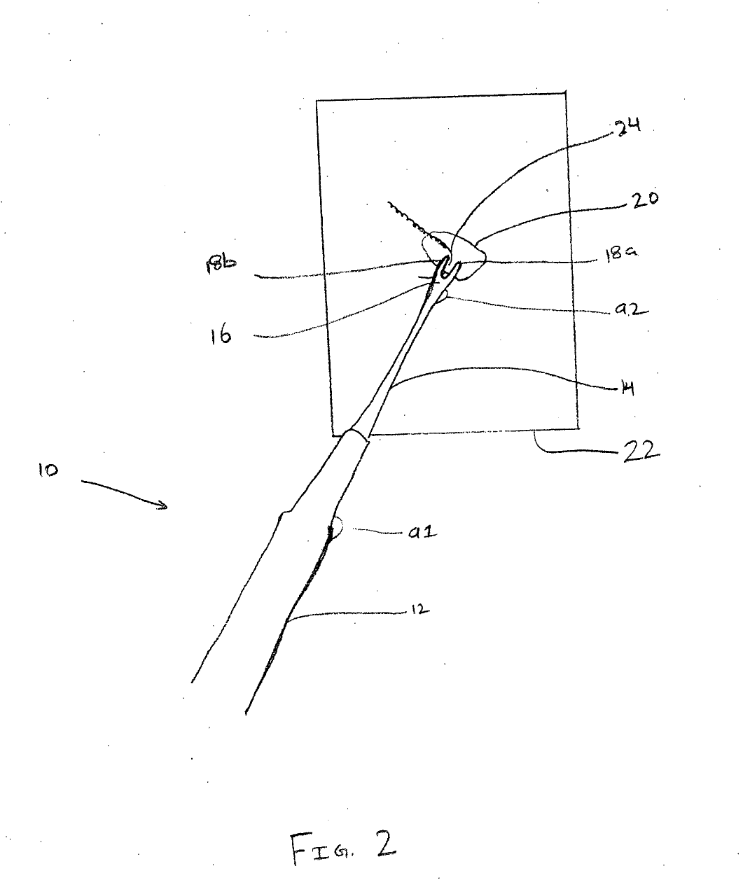

In other embodiments, the protrusions may be angled toward or away from each other. As illustrated in FIG. 2 graft holder 10 can be used extraorally to hold a graft specimen 20 against a sterilized surface 22 to begin suturing using needle 24.

The graft holder instrument according FIG. 1-3 has a bracing member provided with two prongs. In other embodiments, the graft holder may be provided with more than two prongs. The pronged embodiments have an additional function that allows a suturing needle to pass through the space between two prongs while holding the graft or membrane in place during suturing of the graft or membrane to soft tissue.

FIG. 3 illustrates a side view of an embodiment of the graft holder 10. The length of the handle 12 can be, for example within the range of about 3 to about 4 inches long. In other embodiment, the handle may have another suitable length outside of the above-referenced range. The length of the first shank 14 can be, for example, within the range of about 10 to about 30 mm long. In other embodiment, the first shank may have another suitable length outside of the above-referenced range. The length of the second shank 16 can be, for example, within the range of about 10 to about 30 mm long. In other embodiment, the second shank may have another suitable length outside of the above-referenced range. The diameters of the two protrusions 18a and 18b can be, for example within the range of about 0.5 to about 1.5 mm wide. The convergence angle of the two protrusions 18a and 18b can be within the range of about 15 to about 45 degrees relative to the axial dimension of the graft holder 10. The divergence angle of the two protrusions 18a and 18b can be within the range of about 15 to about 45 degrees relative to the axial dimension of the graft holder 10.

In FIG. 3 angle a1 can be between about 15 degrees to about 45 degrees. In one preferred embodiment the a1 is 15 degrees. Angle a2 can be between about 15 to about 90 degrees. However in one preferred embodiment the angle a2 is about 45 degrees. As stated above, the variation in angulations can enable a practitioner to reach further into a patients mouth without obstruction of view or pinching the facial structure of the patient.

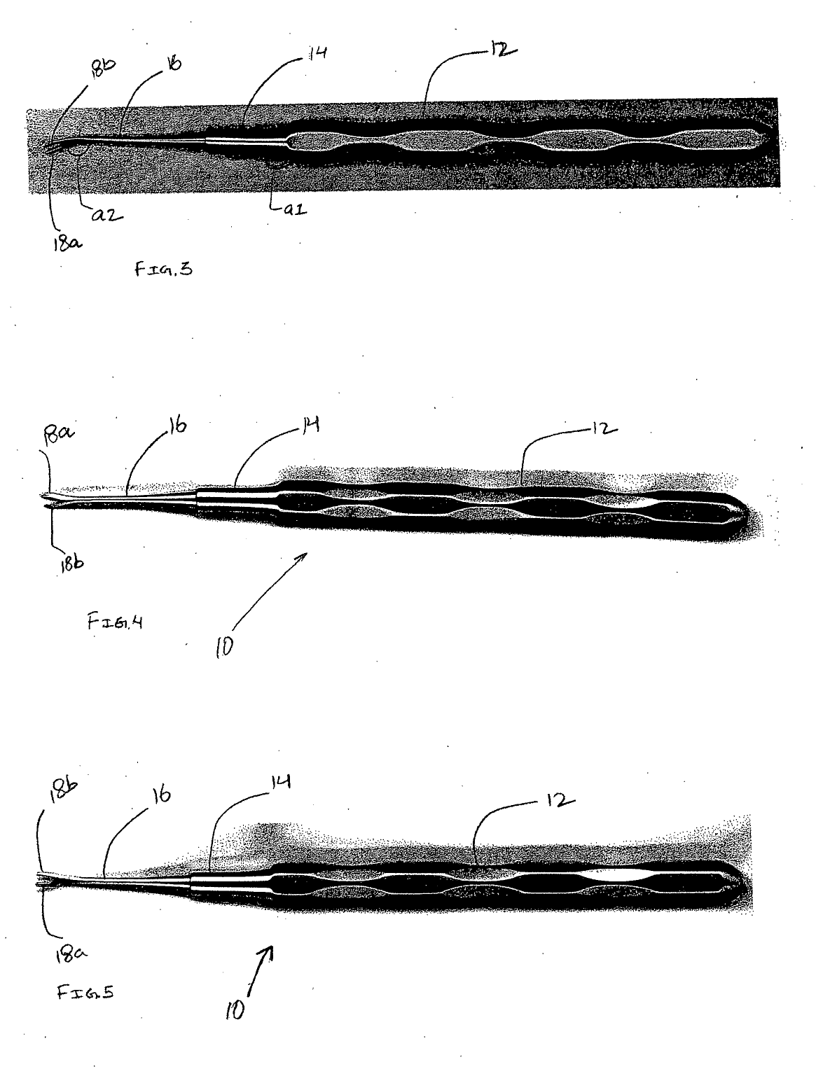

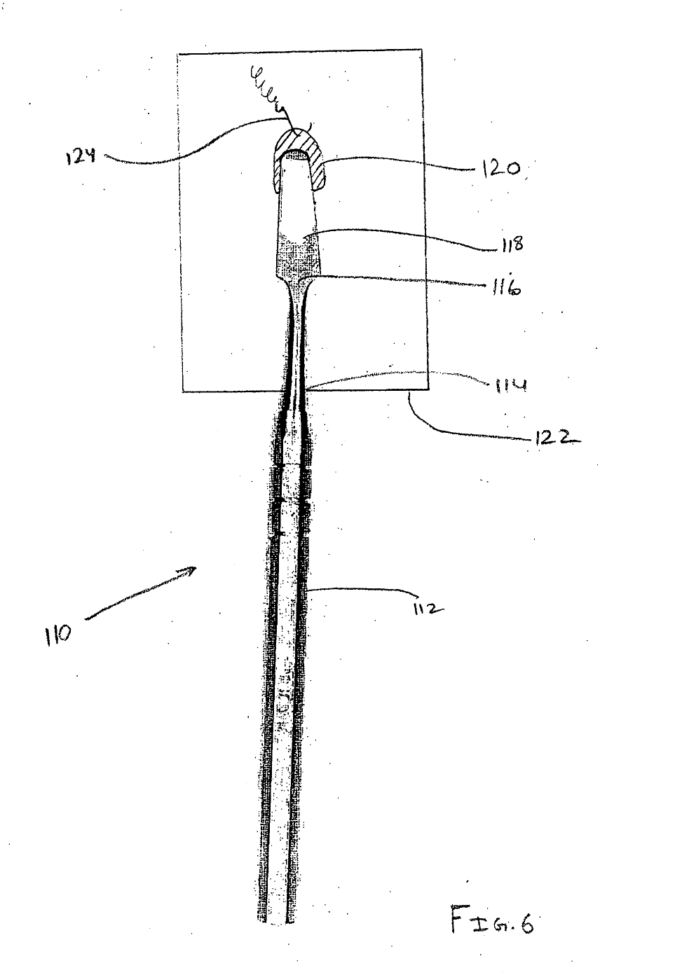

FIG. 4 illustrates a top view of an embodiment of the graft holder 10. The distance between the two prongs can be between about 0.5 to about 2.0 mm, depending on the size of the needle being inserted between them. One preferred measurement of the distance is 1.5 mm. Also the length of each prong can be between about 2 to about 5 mm long depending on the size of the graft. One preferred measurement of the length of each prong is 3.5 mm. FIG. 5 illustrates the bottom view of the an embodiment of the graft holder 10.

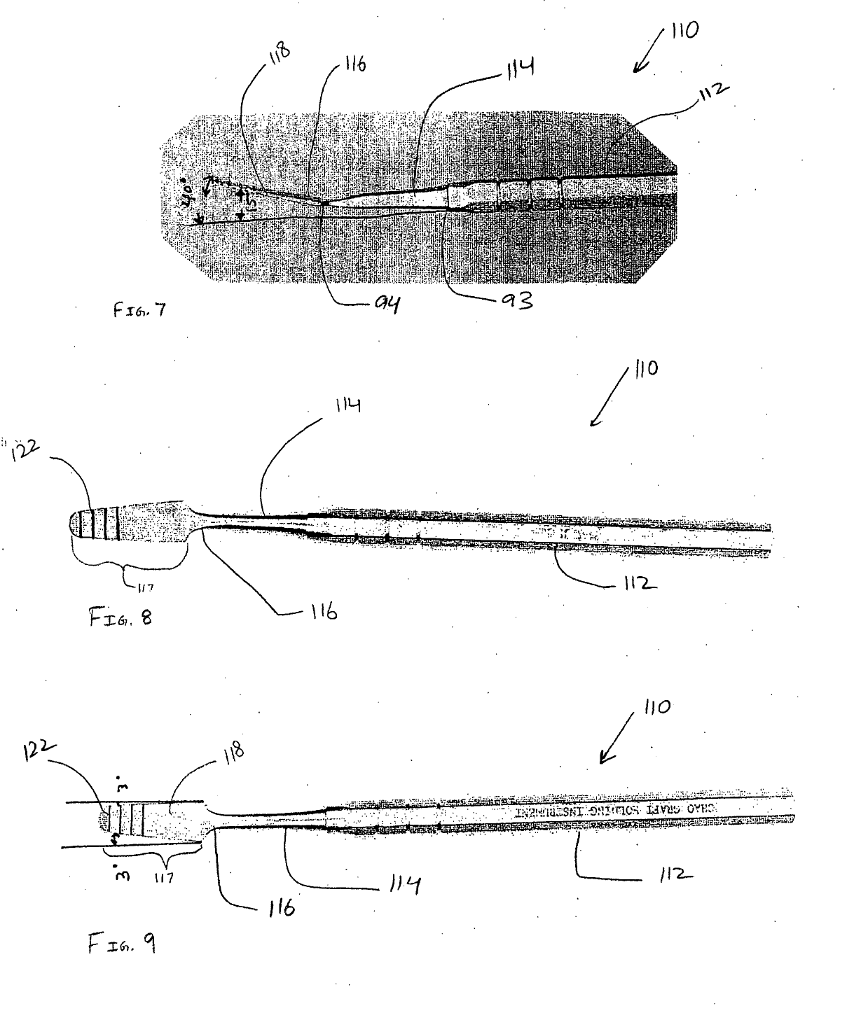

FIG. 6 illustrates another embodiment of the graft holder. In FIG. 6 the graft holder 110 is an instrument with a handle 112, a connector section or first shank 114 linearly extending from the handle 112 at an angle a3, a second shank 116 connected to the first shank 114 at an angle a4 and a bracing member 117 linearly extending from the second shank. The bracing member 117 as shown in FIG. 7-9 may have a generally flat surface 118 that holds the graft specimen or membrane in place. As further shown in FIG. 6, the generally flat surface 118 holds the graft specimen 120 (for example, adjacent to a surgical site intraorally, (not shown) or a sterilized surface 122 extraorally). In another embodiment of graft holder 110 the generally flat surface 118 could also hold the graft specimen 20 against a graft site intraorally by suturing around or on each side of the generally flat surface 118 with the specimen 20 and surrounding soft issue of the graft site.

As illustrated in FIG. 7-9, in one preferred embodiment of graft holder 110 the angles a3 can be about 15 degrees and a4 can be about 40 degrees. However, in further embodiments angle a3 can be within the range of about 15 to about 45 degrees and angle a4 can be between about 15 to about 90 degrees. The variation in angulations can enable a practitioner to reach further into or further location within a patients mouth without obstruction of view or pinching the facial structure of the patient.

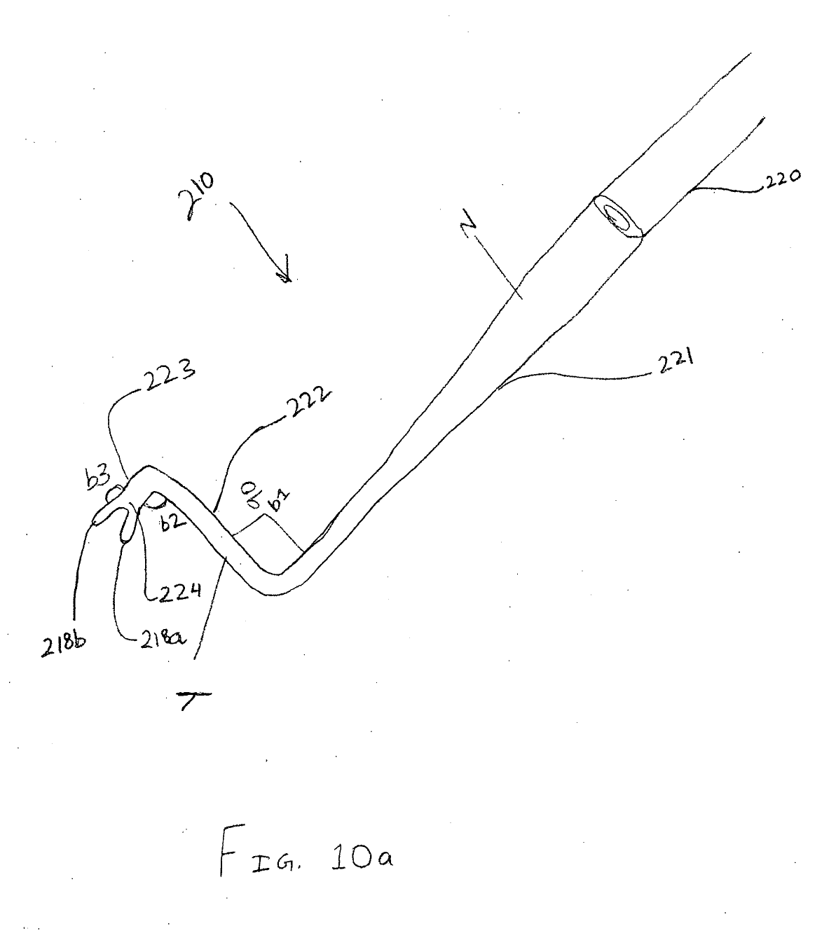

As shown, in FIGS. 8 and 9, the generally flat surface 118 of the graft holder 110 may include one or more discontinuities 122 to help keep the graft or specimen in place on the generally flat surface 118 while suturing through the specimen. In the embodiment of FIG. 8-9, the one or more discontinuities comprises a series of serrations 122, that protrude to a sharp point and are parallel to each other in a direction that is perpendicular to the length direction of the graft holder.

In other embodiments, the discontinuities may comprise serrations in a longitudinal direction; parallel to each other, non-parallel serrations, ridges, groves, bumps, or other discontinuities, materials or designs that increase surface friction and/or surface tension between the generally flat surface 118 and graft specimen 20.

As shown in FIG. 9, generally flat surface 118 can be tapered at the end furthest away from the second shank 116, in a linear direction. The tapering allows for ease of insertion into the mouth along the gum line. The angle of taper (relative to the longitudinal axis of the handle 112) can range from about 15 to 45 degrees.

In yet other embodiments of the current invention, aspects of the embodiment shown in FIGS. 1-5 may be combined with aspects of the embodiment of FIGS. 6-9. For example, forked prongs or protrusions of the embodiment of FIGS. 1-5 may be included on the bracing member 117 of the embodiment of FIGS. 6-9. For example, the bracing member 117 of the embodiment of FIGS. 6-9 may be configured with protruding prongs that taper at the end, to match the taper of the bracing member 117. In yet other embodiments, the pronged bracing member of the embodiment of FIGS. 1-5 may include one or more discontinuities or materials designed to increase the surface friction and/or surface tension between the bracing section and the specimen 20.

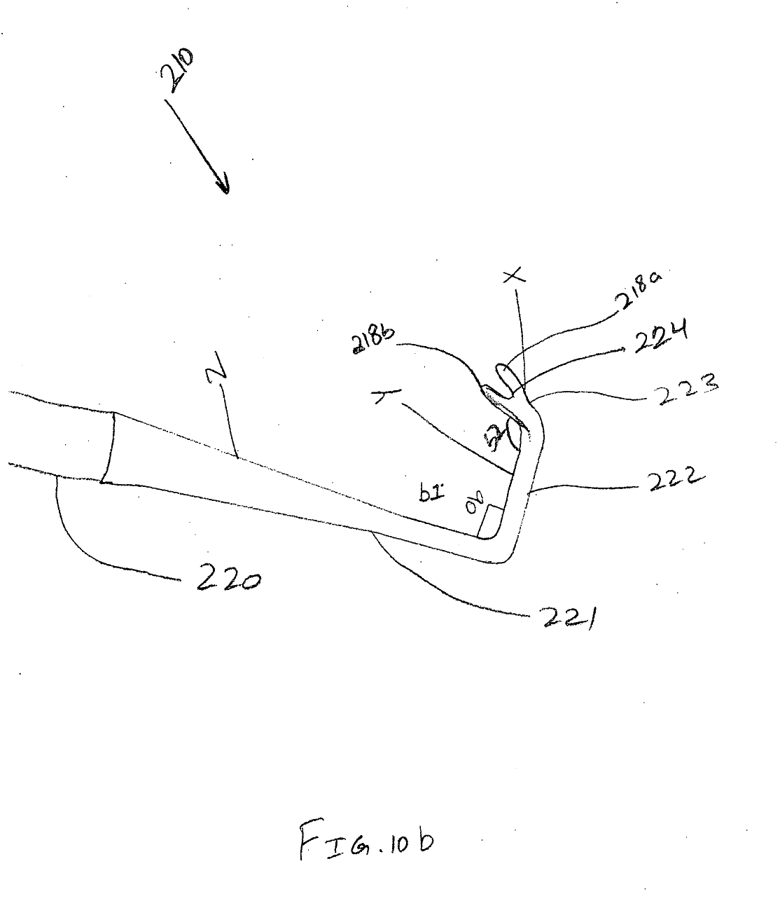

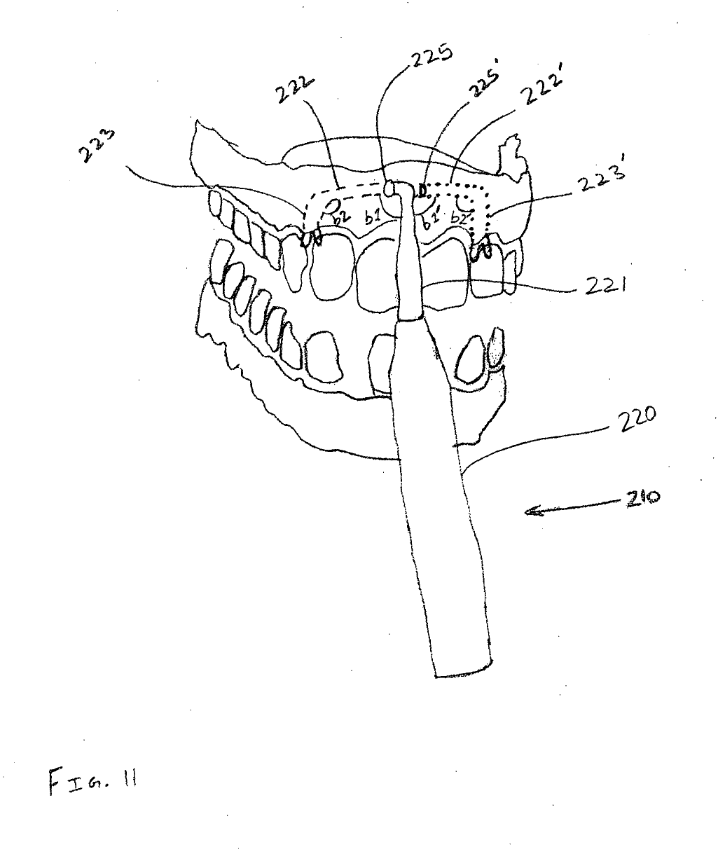

FIG. 10 illustrates another embodiment of the graft holder 210. This embodiment relates to co-pending U.S. patent application Ser. No. 11/498,619, filed Aug. 3, 2006 entitled “Periodontal Surgery and Operation Methods and Instruments” (attorney docket no. 061843.0203), the contents of which is incorporated herein by reference, in its entirety. Graft holder 210 illustrates similar angulations as shown in FIG. 4 of Ser. No. 11/498,619. Graft holder 210 comprises a handle or a shaft 220, a connector or a first shank 221 extending linearly from the shaft 220, a second connector or a second shank 222 connected to the first shank 221 on one end and rotated from the first shank 221 at an angle b1 in the counter-clockwise direction, a third connector or a third shank 223 connected to a second end of the second shank 222 and rotated from the second shank 222 at an angle b2 in the clockwise direction, and a bracing section 224 connected to the third shank 223 rotated at an angle b3 from the third shank 223 in the clockwise direction; wherein the bracing section 224 may be have fork shaped protrusions 218a and 218b.

In yet other embodiments bracing section 224 may be a generally flat surface (not shown) with discontinuities to help keep the graft or specimen in place on the generally flat surface while suturing through the specimen. In the embodiment, the one or more discontinuities comprises a series of serrations 122, that protrude to a sharp point and are parallel to each other in a direction that is perpendicular to the length direction of the graft holder.

The bends as provided in the graft holder 210 provide a means by which a graft can be delivered submucosally or subgingivally through a remote entry point to a location as distant as one or two teeth away. In the Trans-Mucosal-Papillae-Elevation (TMPE approach to root coverage co-pending U.S. patent application Ser. No. 11/498,619, filed Aug. 3, 2006 entitled “Periodontal Surgery and Operation Methods and Instruments” (attorney docket no. 061848.0203), an entry incision of 1-3 mm is made near the bucco-muco fold opposite the root with the defect. Uniquely designed elevators, using the only entry point, allows a flap to be elevated as distant as one to three teeth from the root defect. The papillae of the adjacent teeth are also elevated by these papillae elevators. To stabilize the flap it is sometimes necessary to insert membranous graft material under the elevated papillae. The particular angulations incorporated into graft holder 210 allows the surgeon to deliver the membranous material through the entry site to a point some distance away. Then particular angulations of the instrument allows the membrane to be “tucked” under the respective papillae. Without the particular angulations can be difficult for a surgeon.

The above mentioned techniques is best illustrated in FIG. 11 where graft holder 210 is inserted under the gum tissue at the entry incision 225 and follows a path along the gum tissue to hold the membrane fixated. Also shown in FIG. 11 is two embodiments one that goes into the left direction of the mouth and another that goes into the right direction. The graft holder for the right side has a first connector or first shank 221 connected to the handle 220; a second connector 222 connected to the first shank 221 at an angle b1; a third connector or third shank 223 connected to the end of the second shank 222 at an angle b2.

Similarly another embodiment as shown in FIG. 11 illustrates a graft holder 210 with an incision entry point 225′ and a second connector or second shank 222′ connected to the first shank 221 at an angle b1′; a third shank 223′ connected to the second shank 222′ at an angle b2′.

The various embodiments of the graft holder allow a surgeon or operator to stabilize the graft specimen or membrane while suturing. The two prong of the graft holder allows the surgeon to hold the graft specimen or the membrane in place. At the same time the needle can be treaded between the two prongs so that the surgeon can place the needle at the precise entry point. In other words, concomitantly graft stabilization and precise suturing can be accomplished with this one instrument. The angulations of the shank and connector allow ease of placement in the mouth without obstructing direct vision of the point of needle entry.

The foregoing descriptions of embodiments of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. For example, the above embodiments describe the lengths of various elements of the instruments and the angle between adjoining elements of the instruments. These measurements are intended to illustrate the best modes known of practicing the invention, and do not preclude various modifications and variations within the scope of this invention.

In summary, the embodiments described hereinabove are intended to explain best modes known of practicing the invention and to enable others skilled in the art to utilize the invention in such, or other embodiments and with various modifications required by the particular application(s) and use(s) of the present invention. It is intended that the appended claims be construed to include alternative embodiments of the extent permitted by the prior art.

What is claimed is:

1. A surgical instrument for holding a membrane, the instrument comprising:
a handle;
a first connector section comprising a first end and a second end, the first end connecting to the handle;
a second connector section comprising a first end and a second end, the first end connecting to the first connector section; and,
a bracing member connecting to the second end of the connector section;
the bracing member further comprising:
a generally flat surface at the end or a plurality of protrusions for holding a graft membrane.

2. The instrument of claim 1, wherein, the handle and the first end of the connector section form a first angle; the second end of the connector section and the bracing member forms a second angle in the same direction as the second angle.

3. The instrument of claim 1, wherein the length direction of the handle and the first connector section forms a plane, the length direction of the first connector and the second connector section form a plane that is parallel to the plain formed by the handle and the first connector and the width direction of the bracing member is substantially perpendicular to said plane.

4. The instrument of claim 2, wherein each of the first angle and the second angle is between about 15 to about 90 degrees, and the first connector and the second connector section comprises a straight shank.

5. The instrument of claim 4, wherein the first angle is approximately 15 degrees, and the second angle is approximately 45 degrees.

6. The instrument of claim 1, wherein the bracing member with the generally flat surface may a plurality of serrations.

7. The instrument in claim 6, wherein the serrations end at a sharp point.

8. The instrument in claim 6, wherein the serrations are parallel to each other and run perpendicular to the length direction of the instrument.

9. The instrument in claim 6, wherein the serrations are parallel to each other and run perpendicular or longitudinal to the width direction of the instrument.

10. The instrument in claim 6, wherein the serrations are not parallel to each other and run perpendicular or longitudinal to the width direction of the instrument.

11. The instrument of claim 1, wherein the plurality of protrusions are in a fork shape and are parallel and end in a tapered point.

12. The instrument of claim 11, wherein the plurality of protrusions are at an equal distance from each other sufficiently spaced apart to allow for a suturing needle to pass between two protrusions.

13. The instrument of claim 12, wherein the length of the protrusions is between about 1 to 10 mm.

14. A method of making a surgical instrument for holding a membrane comprising:
providing a handle;
having a first connector section comprising a first end and a second end, the first end connecting to the handle;
having a second connector section comprising a first end and a second end, the first end connecting to the first connector section; and,
providing a bracing member connecting to the second end of the connector section;
the bracing member further comprising:
providing a generally flat surface at the end or a plurality of protrusions for holding a graft membrane,
wherein,
the handle and the first end of the connector section forms a first angle;
the second end of the connector section and the bracing member forms a second angle in the same direction as the second angle.

15. The method of claim 14, wherein providing the length direction of the handle and the first connector section forms a plane, the length direction of the first connector and the second connector section form a plane that is parallel to the plain formed by the handle and the first connector and the width direction of the bracing member is substantially perpendicular to said plane.

16. The method of claim 14, wherein providing each of the first angle and the second angle is between about 15 to about 90 degrees, and the first connector and the second connector section comprises a straight shank.

17. The method of claim 14, wherein providing the bracing member with the generally flat surface may include a plurality of serrations.

18. The method of claim 17, wherein providing the serrations are parallel to each other and run perpendicular or longitudinal to the width direction of the instrument.

19. The method of claim 14, wherein providing the plurality of protrusions are in a fork shape and are parallel and end in a tapered point.

20. The method of claim 19, wherein providing the plurality of protrusions are at an equal distance from each other sufficiently spaced apart to allow for a suturing needle to pass between two protrusions.
